(19) United States
(12) Patent Application Publication
(10) Pub. No.: US 2005/0180456 A1
(43) Pub. Date: Aug. 18, 2005

(54) Method of transporting compressed speech in packet mode in the core network of public land mobile network infrastructures

(75) Inventors: Alain Bultinck, Longpont/Orge (FR); Serge Calu, Pleumeur Bodou (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/055,667

(22) Filed: Feb. 11, 2005

(30) Foreign Application Priority Data
Feb. 12, 2004 (FR) 04 50 252

(51) Int. Cl. H04J 3/22; H04J 3/16; H04L 12/56; H04L 12/28; H04L 12/66

(52) U.S. Cl. 370/465; 370/352

(57) ABSTRACT

One aspect of the present invention consists in a method of transporting compressed speech in packet mode in the core network of public land mobile network infrastructures over a core network segment including a pair of transcoders equipped to operate in a tandem-free operation mode enabling transportation of compressed speech over said segment, said transcoders being adapted to format the compressed speech in a first format including compressed speech data and uncompressed speech data, in which method, for optimum transport in packet mode over the whole or a portion of said segment, said first format is changed to a second format including only compressed speech data.

The present invention relates generally to public land mobile network infrastructures.

Public land mobile network infrastructures are generally covered by standards and the corresponding standards published by the corresponding standardization organizations may be consulted for more information.

A public land mobile network (PLMN) generally comprises a radio access network (RAN), primarily responsible for transmission and for managing radio resources at the radio interface between the network and mobile terminals, and a core network (CN), primarily responsible for routing and managing calls. The calls concerned may involve mobile terminals of the same PLMN (in which case routing is internal to that PLMN) or mobile terminals of other PLMNs (in which case routing is effected via one or more transit networks). The core network of PLMN infrastructures therefore includes the core network of one or more PLMNs and one or more transit networks.

Changing requirements and advances in technology generally lead to distinguishing between different types of public land mobile networks, and in particular between second generation systems and third generation systems. A typical example of a second generation system is the GSM (Global System for Mobile communication). A typical example of a third generation system is the UMTS (Universal Mobile Telecommunication System).

Changing requirements and advances in technology also generally lead to distinguishing between different technologies, and in particular between circuit-oriented technologies and packet-oriented technologies.

Changing requirements and advances in technology generally further lead to distinguishing between successive versions of the standard, and in particular between:
a first version (R3 or R99), in which the greatest changes compared to second generation systems such as the GSM concern the introduction of new radio access technologies and in which the core network uses existing second generation infrastructures as much as possible, and
version R4 and later versions, in which the most important changes concern the circuit domain of the core network, with the introduction of the packet transport technology and the separation of user data streams and control data.

A general problem in the above systems, in the case of user data corresponding to speech, is making efficient use of available transport resources without degrading speech quality.

Various coding techniques have been developed to produce compressed speech optimized for transmission over the radio interface. Accordingly, in systems such as the GSM and the UMTS, different coding modes have been defined such as, for the GSM, the FR (full rate), HR (half rate) and EFR (enhanced full rate) modes and, for the GSM and the UMTS, the AMR (adaptive multi-rate) mode.

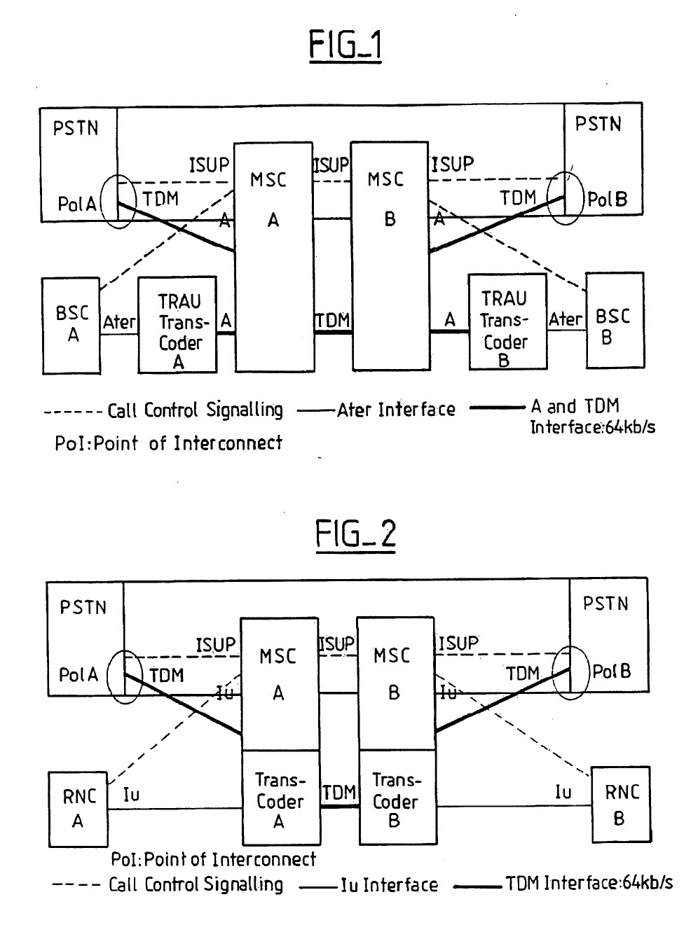

In versions of the standard prior to the R4 version, coding of speech for transmission in the core network uses the PCM (pulse code modulation) technique, as defined in ITU-T Recommendation G.711 in particular, allowing transport of uncompressed speech in the form of 64 kbit/s coded samples. Transcoders, also known as TRAU (transcoder rate adaptation units), are then provided to change from compressed speech optimized for transmission over the radio interface to PCM coded speech (as indicated in FIG. 1 for the GSM, for example, and in FIG. 2 for the UMTS, for example, both of these figures being taken from the document 3GPP TR 23.977 published by the 3GPP (3rd Generation Partnership Project).

Remember that in a system such as the GSM, for example, transcoders or TRAU are provided between radio access network elements called BSC (base station controllers) and core network elements called MSC (mobile switching centres), the BSC-TRAU interface is called the “Ater” interface and the TRAU-MSC interface is called the “A” interface.

Remember also that in a system such as the UMTS, for example, transcoders are provided in core network elements known as MSC (mobile switching centres) and the interface between radio access network elements called RNC (radio network controllers) and transcoders is called the “Iu” interface.

As indicated in FIGS. 1 and 2, in systems such as the GSM and the UMTS, for example, under versions of the standard prior to the R4 version, the transport technology used in the core network, for example between the MSCs labeled “MSC A” and “MSC B”, is a circuit-oriented technology, in this instance the TDM (time division multiplex) technology based on time-division multiplexing of channels or 64 kbit/s PCM coded samples.

A TFO (tandem-free operation) mode has also been defined to avoid double transcoding in the situation of mobile to mobile calls, to prevent speech quality from being degraded.

The TFO mode is activated by using a TFO protocol that uses in-band signaling between transcoders after setting up the call, in particular in order to negotiate a common coding mode for both mobiles concerned.

Once the TFO mode has been activated, compressed speech may be exchanged between transcoders in TFO frames transported on subchannels at a bit rate that is a submultiple of 64 kbit/s. For example, in the case of full rate (FR) coding, compressed speech is transported in 16 kbit/s subchannels defined by the two least significant bits (LSB) of the 64 kbit/s coded speech samples. For example, in the case of half-rate (HR) coding, compressed speech is transported in 8 kbit/s subchannels defined by the LSB of the 64 kbit/s coded speech samples. To facilitate-interruption of the TFO mode, the most significant bits (MSB) of the 64 kbit/s PCM speech samples corresponding to uncompressed speech are transmitted unchanged. For a more comprehensive description of the TFO functionality, see in particular the technical specification 3GPP TS 28.062 published by the 3GPP (3rd Generation Partnership Project).

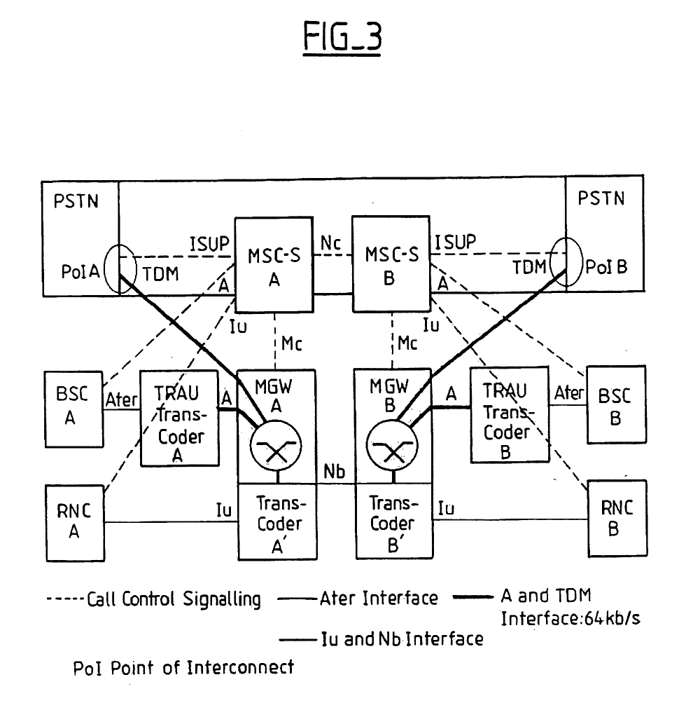

As indicated in FIG. 3, in an NGN (next generation network) architecture, under version R4 of the standard, MSC entities as described with reference to FIGS. 1 and 2 are replaced by entities of two types, namely MGW (media gateway) entities, primarily responsible for user data transport functions, and S-MSC (serving MSC) entities, primarily responsible for control functions.

The NGN concept includes in particular the following features:
the user plane transport technology used in the core network over the “Nb” interface between MGW entities, for example the entities MGW A and MGW B in FIG. 3, is a packet-oriented technology, in particular the ATM (asynchronous transfer mode) technology, using the AAL2/ATM protocols (the AAL2 protocol is the ATM Adaptation Layer type 2 protocol) or the IP (Internet Protocol) technology, using the RTP/IP protocols (the RTP protocol is the Real Time Protocol), and
the control plane between serving MSCs uses the BICC (bearer independent call control) concept.

An OoBTC (out-of-band transcoder control) option in the BICC concept authorizes out-of-band negotiation of an end-to-end coding mode for the user plane by the control plane before setting up the call. Because the transport packet technology allows direct transport of compressed speech on a packet medium, it follows that compressed speech may be transported end-to-end between two mobiles without any transcoder being necessary. This is the TrFO (transcoder-free operation) mode. For a more comprehensive description of the TrFO functionality, see in particular the technical specification 3GPP TS 23.153.

Like the TFO mode, the TrFO mode avoids degrading speech quality by avoiding successive transcoding in the user plane. However, unlike the TFO mode, in which it is not possible, the TrFO mode also has the advantage of economizing on transmission resources in the core network.

It is predicted that the core network architecture, including that of the core network of second and third generation mobile networks and PLMNs and that of fixed networks used by PLMNs as transit networks, will increasingly evolve towards the NGN architecture.

However, it is foreseen that it will not be possible to deploy the TrFO functionality totally in these networks, in the following situations in particular:
in the case of GSM access, the coding mode used is not communicated to the core network, so that even if the network is able to use the out-of-band negotiation option, the only coding mode that the core network has available is the default mode, namely the PCM (G.711) mode,
in the case of transit networks that do not use the NGN architecture, for example transit networks corresponding to the PSTN (public switched telephone network), and
in the case of transit networks that use the NGN architecture but do not use the out-of-band coding mode negotiation option.

For the above reasons, it may be expected that the TFO and TrFO technologies will be used conjointly for a long time to come, the TFO technology being used in segments of the core network that do not have the benefit of the TrFO technology and the TFO protocol being activated after setting up a call only if there are transcoders in the user data path.

Given this background, the present invention addresses certain problems that arise, which may be stated in the following terms, for example.

On a segment of the core network on which the TrFO technology is not available and that uses a packet transport technology, for example between second generation MSCs that have evolved towards the NGN architecture, as mentioned above, the TFO technology leads to transporting TFO frames in 16 kbit/s or 8 kbit/s subchannels defined by two or one of the eight bits forming the 64 kbit/s coded samples, which are themselves sent via the AAL2/ATM protocol layers. As the TFO uses only two or one of the eight bits forming a coded sample to transport compressed speech, some of the bandwidth of the core network segment concerned is wasted.

One particular object of the present invention is to overcome and/or to prevent such problems. More generally, one object of the present invention is to optimize transport in the above networks, especially in terms of use of available transport resources and improved speech quality.

In one aspect the present invention consists in a method of transporting compressed speech in packet mode in the core network of public land mobile network infrastructures over a core network segment including a pair of transcoders equipped to operate in a tandem-free operation mode enabling transportation of compressed speech over said segment, said transcoders being adapted to format the compressed speech in a first format including compressed speech data and uncompressed speech data, in which method, for optimum transport in packet mode over the whole or a portion of said segment, said first format is changed to a second format including only compressed speech data.

In another aspect the present invention consists in a public land mobile network infrastructure core network node comprising means for implementing a method of the above kind.

Other objects and features of the present invention will become apparent on reading the following description of examples of the invention, which is given with reference to the appended drawings, in which:

FIGS. 1 and 2 outline the network architecture used for the GSM and for the UMTS, respectively, prior to version R4 of the standard,

FIG. 3 outlines the NGN architecture used subsequently to version R4 of the standard, and

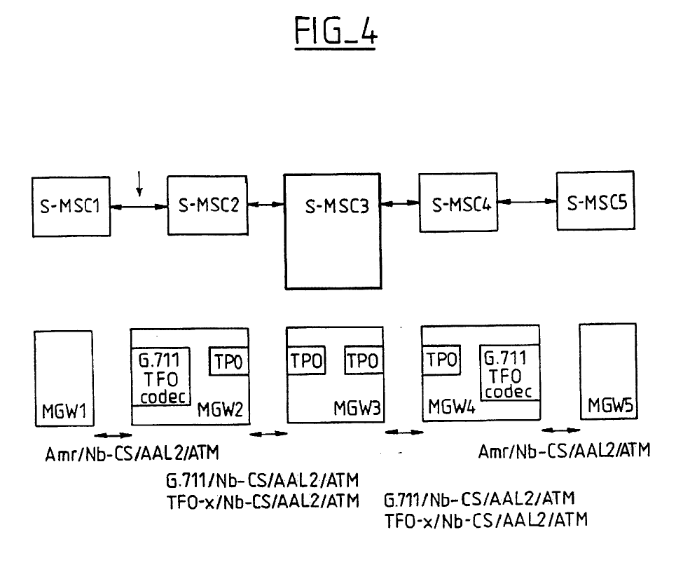

FIGS. 4, 5 and 6 show examples of the general principles of the present invention.

FIG. 4 considers by way of example media gateway entities MGW1 to MGW5 corresponding to core network nodes for sending user data, in particular speech, in packet mode, for example using the ATM technology, and associated with respective serving MSC entities S-MSC1 to S-MSC5, as indicated hereinabove.

There is considered by way of example a situation in which the entities S-MSC2, S-MSC3, and S-MSC4 are not equipped to support the TrFO functionality, so that a pair of transcoders must be inserted into the segment MGW2-MGW3-MGW4, these transcoders being provided in the nodes MGW2 and MGW4, respectively, in this instance.

The transcoders are labeled “G.711 TFO codec” to indicate that they enable a change from a coding mode with speech compression to a coding mode without speech compression corresponding to the PCM mode defined in ITU-T Recommendation G.711 and that they support the TFO functionality as defined in the GSM and UMTS recommendations.

In the example shown in FIG. 4, speech transported outside the segment MGW2-MGW3-MGW4 corresponds to compressed speech coded in the AMR mode. The compressed speech in the AMR mode is in turn encapsulated in a framing protocol, which could be the Nb-CS protocol in a UMTS/GSM environment or a different protocol in other network environments (ITU 1.366.2 or IETF AVT, for example); the Nb-CS/AMR packets obtained in this way are themselves transported in ATM cells or packets in accordance with the AAL2/ATM transport protocols, the of these processes being labeled AMR/Nb-CS/AAL2/ATM.

In the FIG. 4 example, if the TFO mode is not activated, the speech transported on the segment MGW2-MGW3-MGW4 corresponds to PCM (G.711) coded uncompressed speech. The 64 kbit/s PCM (G.711) samples are in turn encapsulated in a framing protocol as indicated hereinabove. The G.711/Nb-C5 packets obtained in this way are themselves transported in ATM cells or packets in accordance with the AAL2/ATM transport protocols, the combination of these processes being labeled G.711/Nb-CS/AAL2/ATM.

In the example shown in FIG. 4, the present invention proposes to introduce, into each of the nodes of the segment MGW2-MGW3-MGW4 concerned, a new functionality referred to hereinafter as the TPO (TFO packet optimizer) functionality. In the example shown in FIG. 4, a TPO entity is therefore provided in each of these nodes at each termination of a connection between two nodes.

In the example shown in FIG. 4, because of the TPO function, if the TFO mode is activated, speech transported on the segment MGW2-MGW3-MGW4 corresponds to compressed speech transported in a format corresponding to TFO-2 frames, for example, or more generally to TFO-x frames, where “x” indicates the number of bits corresponding to compressed speech in a 64 kbit/s coded sample, where “x” is an integer from 1 to 7 and generally has the value 1 or 2, the bit rate of compressed speech generally not exceeding 16 kbit/s. The TFO-x frames are encapsulated in a framing protocol, for example the Nb-CS protocol in a 3GPP environment or a different protocol in a fixed environment. The TFO-x/Nb-CS packets obtained in this way are themselves transported in ATM cells or packets in accordance with the AAL2/ATM transport protocols, the combination of these processes being labeled TFO-x/Nb-CS/AAL2/ATM.

In other words, in the example shown in FIG. 4, for optimum transport in packet mode over the whole of the segment MGW2-MGW3-MGW4 concerned, a first format including compressed speech data and uncompressed speech data is changed to a second format including only compressed speech data. In this example, said first format corresponds to coded samples including “x” compressed speech bits and “n-x” uncompressed speech bits, where “n” is the number of bits in the samples, and said second format corresponds to coded samples including only “x” compressed speech bits.

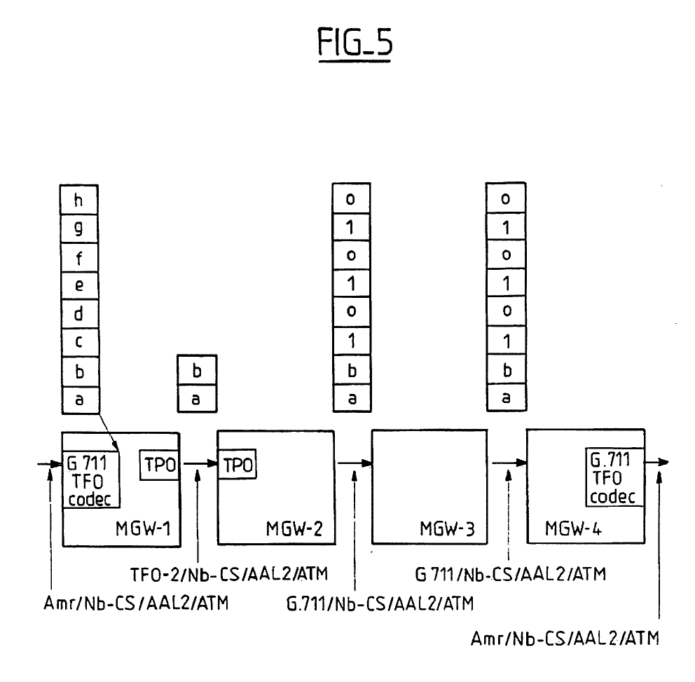

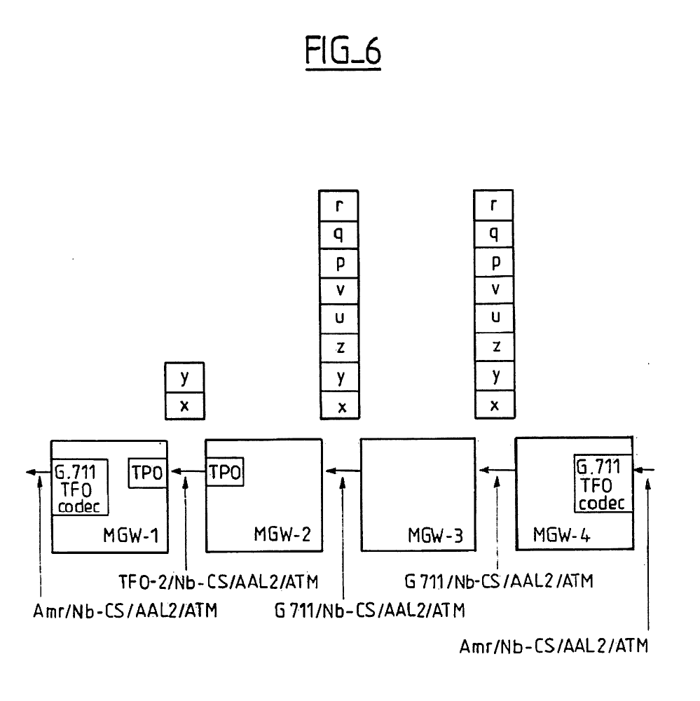

Certain functions or properties of the TPO functionality in the examples given here are indicated hereinafter:
The TPO functionality is linked to transport and does not necessarily need to be known at the control layer level.
For the TPO functionality to be active, a TPO entity must be provided at each end of a connection between two nodes. For the purposes of the TPO functionality, the TPO entities provided at the ends of a connection are also referred to as homologous entities.
An MGW node may have a TPO entity at each end. A MGW node may also have a TPO entity at one end. the homologous MGW entity supporting the TPO functionality, and not at the other end, the homologous MGW entity not supporting the TPO functionality. Various situations are described below with reference to FIGS. 5 and 6.
The capacity to implement the TPO functionality between two nodes could be static whereby each node, by prior configuration or “provisioning”, knows if each adjacent node has the TPO capability or dynamic whereby “TPO negotiation” between two nodes is effected using the transport control protocol, for example, such as the IPBCP or the Q.2630 protocol. In other words, for each call, a MGW node is capable of recognizing if the next node is equipped to process speech data in said second format, either by prior configuration or by means of a signaling protocol.
The TPO functionality is independent of the framing protocol used to transport the data over the packet transport network. For example, in the case of the Nb-CS protocol, which provides an initialization procedure for fixing the size of the data blocks that can be exchanged under this protocol, the possible data block sizes, indicated by an RAB subflow combination indicator (RSCI) parameter, could take into account the TPO functionality. In the example considered here, the size can take up to seven possible values, for example, corresponding to the seven possible values of the parameter “x”. For example, under the 1.366.2 protocol, a new profile can be defined to take into account the TPO functionality, including eight possibilities: G.711, TFO-x with “x” from 1 to 7.
The TPO functionality is independent of the voice coders used.
A TPO entity includes synchronization and resynchronization functions.

On setting up a call, a TPO entity in a given node starts up in a “transparent” mode in which it forwards data that it receives either from the transcoder “G.711 TFO codec”, if a transcoder of this kind is provided in the node concerned, which is the case for the node MGW1 in FIG. 5, for example, or a TFO entity in another node, which is the case for the node MGW2 in FIG. 6, for example, which receives said data from a TFO entity in the node MGW4. In parallel with this, the TPO entity concerned detects if a TFO-x coding mode has been negotiated, and if so looks for the frame synchronization pattern for the TFO-x frames. If the TPO entity succeeds in synchronizing, it goes to a different mode in which it sends only data transported in TFO-x frames. In other words, the TPO entity goes to another mode in which said first format is changed to a second format. This change to another mode is naturally indicated to the homologous TPO entity packet by packet in the header of the framing protocol. Then, if the TPO entity concerned does not succeed in synchronizing to the TFO-x frames, it returns to the original G.711 mode, which is also indicated to the homologous TPO entity.

A TPO entity may also include functions for changing the format to a third format including compressed speech data and meaningless data. A format change of this kind is effected if the next node is not equipped to support the TPO functionality. In the example considered here, said third format corresponds to coded samples including “x” compressed speech bits and “n-x” meaningless bits.

In FIGS. 5 and 6, a segment MGW2-MGW3-MGW4 is considered by way of example, with transcoders in the nodes MGW1 and MGW4, and the situation considered by way of example is that in which the nodes MGW1, MGW2 and MGW4 support the TPO functionality and the node MGW3 does not support the TPO functionality.

The FIG. 5 example relates more particularly to the transmission direction from MGW1 to MGW4 and the FIG. 6 example relates more particularly to the transmission direction from MGW4 to MGW1.

In the FIG. 5 example, operation may be as follows, for example.

The transcoder “G711 TFO codec” in the node MGW1 first starts up in G.711 mode and negotiates a coding mode compatible with the homologous entity in the node MGW4 by means of in-band signaling, using a bit stealing technique to steal bits from PCM coded speech samples.

If the negotiation succeeds, the TFO mode is activated and the transcoder then goes to a “TFO-x” mode in which the coded speech samples comprise, as shown in FIG. 5 for the situation where “x” is equal to 2:
two LSB, in this instance the bits “a” and “b”, corresponding to compressed speech, and
six MSB, in this instance the bits “c” to “h”, corresponding to the MSB of a PCM speech sample.

Before activation of the TFO mode, the TPO entity in the node MGW1 forwards the PCM samples that it receives from the transcoder and searches the signaling exchanged in accordance with the TFO protocol for the negotiated “TFO-x” mode. In the example considered here, where this is the “TFO-2” mode, the TPO entity then attempts to synchronize to the TFO-2 frames received from the transcoder after which, once synchronization has been acquired, it omits the bits “c” to “h” of the coded speech samples supplied by the transcoder and generates packets to be sent to the TPO entity of the next node MGW2, also known as TFO-2 packets, from only the bits “a” and “b” of those samples.

The node MGW2 detects that the next node MGW3 is not equipped to support the TPO functionality and, as shown in FIG. 5, generates from samples received from the node MGW2 comprising the bits “a” and “b” samples comprising:
two LSB, in this instance the bits “a” and “b”, corresponding to compressed speech, and
six meaningless MSB, for example the bits “101010”.

The node MGW3, which is not equipped to support the TPO functionality, behaves like a conventional node and forwards speech samples received from the node MGW2 to the node MGW4.

In the node MGW4, the transcoder “G.711 TFO codec”, which is synchronized to the TFO-2 frames, can extract the bits “a” and “b” corresponding to compressed speech and can then forward the compressed speech to the next node (not shown), in the AMR mode in the example shown.

In the FIG. 6 example, operation may be as follows, for example.

The transcoder “G.711 TFO codec” in the node MGW4 knows that the TFO mode has been activated by virtue of the signaling exchanged in accordance with the TFO protocol. However, as the next node MGW3 is not equipped to support the TPO functionality, even after activation of the TFO mode, the node MGW4 supplies PCM speech samples conforming to the G.711 recommendation and comprising, as shown in FIG. 6:
two LSB, in this instance the bits “x” and “y”, corresponding to compressed speech, and
six MSB, in this instance the bits “z”, “u”, “v”, “p”, “q”, “r”, corresponding to the MSB of a PCM speech sample.

The node MGW3, which is not equipped to support the TPO functionality, behaves like a conventional node and forwards speech samples received from the node MGW4 to the node MGW2.

The node MGW2, which is equipped to support the TPO functionality, detects that the next node MGW1 is equipped to support the TPO functionality and that the TFO-2 mode has been activated. It then generates packets to be sent to the TPO entity of the next node MGW1, also known as TFO-2 packets, from only the bits “x” and “y” of the speech samples.

In the node MGW1, the transcoder “G.711 TFO codec”, which has been synchronized to the TFO-2 frames, can extract the bits “x” and “y” corresponding to compressed speech and can then forward the speech to the next node (not shown) in the compressed (AMR) mode.

In other words, in the examples shown in FIGS. 5 and 6, for optimum transport in packet mode over a portion MGW1-MGW2 of the segment MGW2-MGW3-MGW4 concerned, a first format including compressed speech data and uncompressed speech data is changed to a second format including only compressed speech data. In the example shown in FIG. 5, over another portion MGW2-MGW3-MGW4 of the same segment, said second format is changed to a third format including compressed speech data and meaningless data.

In the examples shown in FIGS. 4, 5 and 6:
a node of the segment concerned receiving speech data in said first format and detecting that the next node is equipped to process speech data in said second format effects a change from said first format to said second format for sending to said next node,
a node of the segment concerned receiving speech data in said second format and detecting that the next node is equipped to process speech data in said second format forwards said data in said second format to said next node, and
a node of the segment concerned receiving speech data in said second format and detecting that the next node is not equipped to process speech data in said second format effects a change from said second format to a third format including compressed speech data and meaningless data for sending to said next node.

Additionally, although this is not shown:
a node of the segment concerned receiving speech data in said third format and detecting that the next node is equipped to process speech data in said second format could effect a change from said third format to said second format for sending to said next node.

Moreover, in these examples:
a node of the segment concerned detects that speech data received is in said first format by detecting if the TFO mode has been activated.

Moreover, in these examples:
a node of the segment concerned indicates to at least one subsequent node of said segment if it effects a change from said first format to said second format for sending to said next node.

Moreover, in these examples:
speech data blocks being encapsulated in a framing protocol for transfer between core network nodes, a node indicates to at least one subsequent node if it effects a format change by means of an indication of the format of said data blocks sent in accordance with said framing protocol.

Moreover, in these examples:
a node of the segment concerned can either be configured to recognize if the next node to which it sends speech data is equipped to process speech data in said second format or to detect if the next node to which it sends speech data is equipped to process speech data in said second format by virtue of the signaling protocol used for each call.

Moreover, in these examples:
said first format corresponds to coded samples including “x” compressed speech bits and “n-x” uncompressed speech bits, where “n” designates the number of bits in the samples,
said second format corresponds to coded samples including only “x” bits of compressed speech, and
said third format corresponds to coded samples including “x” bits of compressed speech and “n-x” meaningless bits, where “n” designates the total number of bits in a coded sample.

Moreover, in these examples:
said framing protocol including an initialization procedure for fixing the size of the data blocks that can be exchanged in accordance with this protocol, the possible data block sizes include the various possible values “x”.

The present invention also provides a core network node for public land mobile network infrastructures comprising means for implementing the above method, i.e. comprising means for implementing the different steps of such a method, individually or in combination.

The particular implementation of such means causing no particular problem for the person skilled in the art, such means do not need to be described here in any more detail than by stating their function, as above.

1. A method of transporting compressed speech in packet mode in the core network of public land mobile network infrastructures over a core network segment including a pair of transcoders equipped to operate in a tandem-free operation mode enabling transportation of compressed speech over said segment, said transcoders being adapted to format the compressed speech in a first format including compressed speech data and uncompressed speech data, in which method, for optimum transport in packet mode over the whole or a portion of said segment, said first format is changed to a second format including only compressed speech data.

2. A method according to claim 1, wherein said first format corresponds to coded samples including “x” compressed speech bits and “n-x” uncompressed speech bits, where “n” is the total number of bits in a coded sample, and said second format corresponds to coded samples including only “x” compressed speech bits.

3. A method according to claim 1, wherein a node of said segment receiving speech data in said first format and detecting that the next node is equipped to process speech data in said second format effects a change from said first format to said second format for sending to said next node.

4. A method according to claim 1, wherein a node of said segment receiving speech data in said second format and detecting that the next node is equipped to process speech data in said second format forwards said data in said second format to said next node.

5. A method according to claim 1, wherein a node of said segment receiving speech data in said second format and detecting that the next node is not equipped to process speech data in said second format effects a change from said second format to a third format including compressed speech data and meaningless data for sending to said next node.

6. A method according to claim 5, wherein a node of said segment receiving speech data in said third format and detecting that the next node is equipped to process speech data in said second format effects a change from said third format to said second format for sending to said next node.

7. A method according to claim 5, wherein said third format corresponds to coded samples comprising “x” compressed speech bits and “n-x” meaningless bits, where “n” is the total number of bits in a coded sample.

8. A method according to claim 2, where “n” is equal to 8 and the value of “x” is from 1 to 7.

9. A method according to claim 7, where “n” is equal to 8 and the value of “x” is from 1 to 7.

10. A method according to claim 1, wherein a node of said segment detects that received speech data is in said first format by detecting if the tandem-free operation mode has been activated.

11. A method according to claim 3, wherein a node of said segment informs at least one subsequent node of said segment if it effects a change from said first format to said second format for sending to said next node.

12. A method according to claim 11, wherein speech data blocks are encapsulated in a framing protocol for transfer between core network nodes and a node informs at least one subsequent node if it effects a format change by means of a format indication for said data blocks sent in accordance with said framing protocol.

13. A method according to claim 11, wherein said first format corresponds to coded samples including “x” compressed speech bits and “n-x” uncompressed speech bits, where “n” is the total number of bits in a coded sample, and said second format corresponds to coded samples including only “x” compressed speech bits, and wherein said framing protocol includes an initialization procedure for fixing the size of the data blocks that can be exchanged in accordance with that protocol and the possible data block sizes include the various possible values of “x”.

14. A method according to claim 3, wherein a node of said segment is configured to recognize if the next node to which it sends speech data is equipped to process speech data in said second format.

15. A method according to claim 3, wherein a node of said segment detects if the next node to which it sends speech data is equipped to process speech in said second format by means of the signaling protocol used for each call.

16. A core network node for public land mobile network infrastructures, comprising means for implementing a method according to claim 1.
